(19) United States
(12) Patent Application Publication
(10) Pub. No.: US 2012/0288818 A1
(43) Pub. Date: Nov. 15, 2012

(54) METHOD OF MANAGING AN ORTHODONTIC ALIGNER SCHEDULE

(76) Inventor: Bruno L. Vendittelli, Toronto (CA)

(21) Appl. No.: 13/467,342

(22) Filed: May 9, 2012

Related U.S. Application Data
(60) Provisional application No. 61/484,002, filed on May 9, 2011.

(51) Int. Cl. A61C 7/00

(52) U.S. Cl. 433/24

(57) ABSTRACT

A method of managing a schedule of orthodontic aligners (30) using an aligner manager (20). The method includes calculating the orthodontic aligner schedule (30) according to a plurality of scheduling formulas, and presenting an interactive profile page (32) on a graphical user interface for displaying a summary of the calculated orthodontic schedule (30) and for allowing a user to interact with the aligner manager (20) and independently manage the orthodontic aligners. The method also includes presenting a plurality of interactive schedule prompts (34, 42, 48, 50) on the graphical user interface for allowing the user to enter a treatment preference and request a recalculation of the aligner schedule (30) using the preference and the scheduling formulas. The method proceeds by displaying a summary of the recalculated aligner schedule (30) on the interactive profile page (32) for allowing a user to review and manage the updated schedule.

### CROSS-REFERENCE TO RELATED APPLICATIONS

This application claims the benefit of U.S. Provisional Patent Application Ser. No. 61/484,002, filed on May 9, 2011 and entitled “A Method of Managing an Orthodontic Aligner Schedule.”

### BACKGROUND OF THE INVENTION

1. Field of the Invention

A method of managing a schedule of orthodontic aligners using an aligner manager having computer readable instructions stored on a computer readable medium.

2. Description of the Prior Art

Orthodontic treatment using aligners is becomingly increasingly popular, and the attainment of an ideal end result is predicated on many factors such as proper diagnosis, treatment planning and how well a patient adheres to their aligner schedule. When a patient decides to use orthodontic aligner treatment, a number of aligners are created to straighten the patient's teeth based on a diagnosis of the orthodontist. Once the aligners are created, they are given to the patient and the patient is asked to wear each aligner for a specific period of time. Typically, an orthodontist will distribute 2-4 aligners at a time and the patient is responsible for managing and keeping track of his or her schedule. Currently patients do this by writing it into a calendar, and it is not uncommon for the patient to lose track of their schedule which leads to decreased compliance with the orthodontic treatment plan.

### SUMMARY OF THE INVENTION

The invention provides for a method of calculating an orthodontic aligner schedule according to a plurality of scheduling formulas and presenting an interactive profile page on a graphical user interface for displaying a summary of the calculated orthodontic aligner schedule. The method is advantageous because it allows a user to interact with the aligner manager and independently manage the schedule of orthodontic aligners. Accordingly, an orthodontist or a patient can track and manage the progress of the aligner treatment thus improving the patient's compliance with the calculated schedule. In addition, the interactive profile page provides a summary of the aligner schedule allowing a user to quickly review the aligner schedule. Also, should adjustments be required to the aligner schedule, the method allows for an automatic recalculation of the aligner schedule to accommodate any adjustments or treatment preferences required by the patient.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a home page of an aligner manager;

FIG. 2 is a patient registration page presented on a graphical user interface for allowing the user to input a plurality of patient identification inputs;

FIG. 3 is a create aligner schedule page presented on the graphical user interface for allowing a user to enter a plurality of aligner inputs associated with an orthodontic aligner treatment;

FIG. 4 is an interactive profile page presented on the graphical user interface for displaying a summary of a calculated orthodontic aligner schedule;

FIG. 5 is an update aligner schedule page presented on the graphical user interface for allowing the user to request an extension to the orthodontic schedule;

FIG. 6 is a resume aligner schedule page presented on the graphical user interface for allowing the user to input at least a resume schedule request; and

FIG. 7 is a my patients page presented on the graphical user interface for allowing the orthodontist to view a summary of the calculated aligner schedule for each patient.

### DETAILED DESCRIPTION OF THE ENABLING EMBODIMENTS

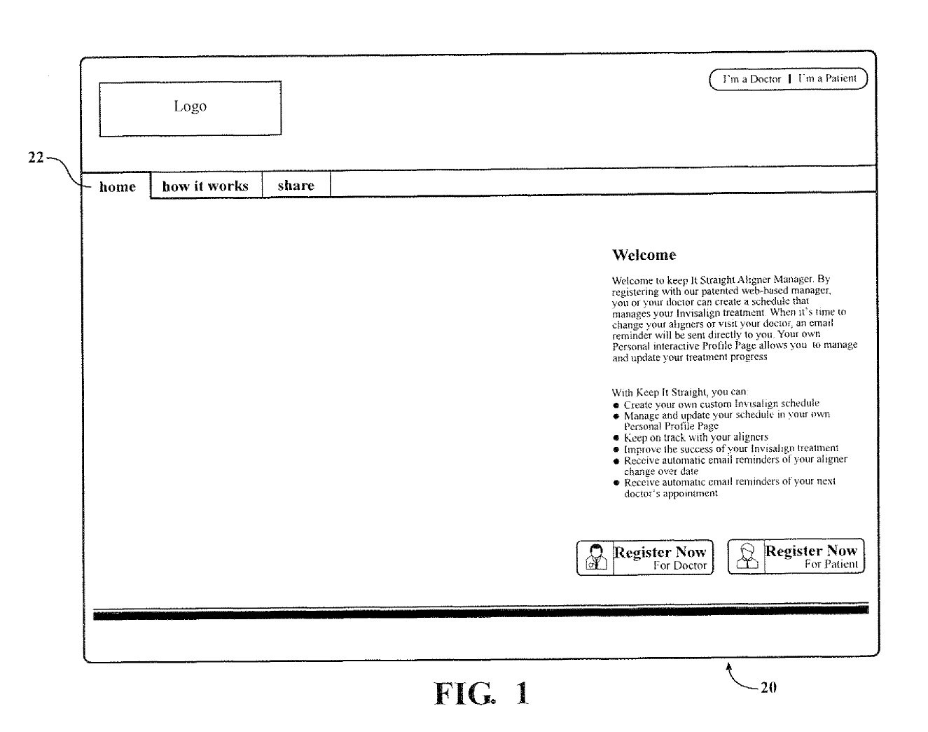

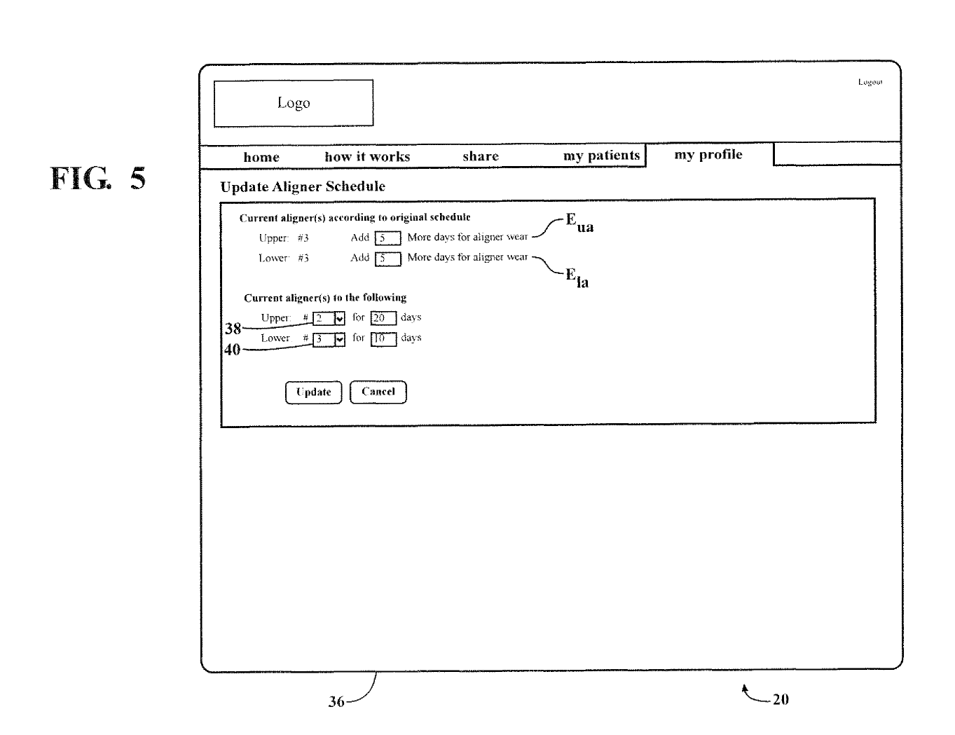

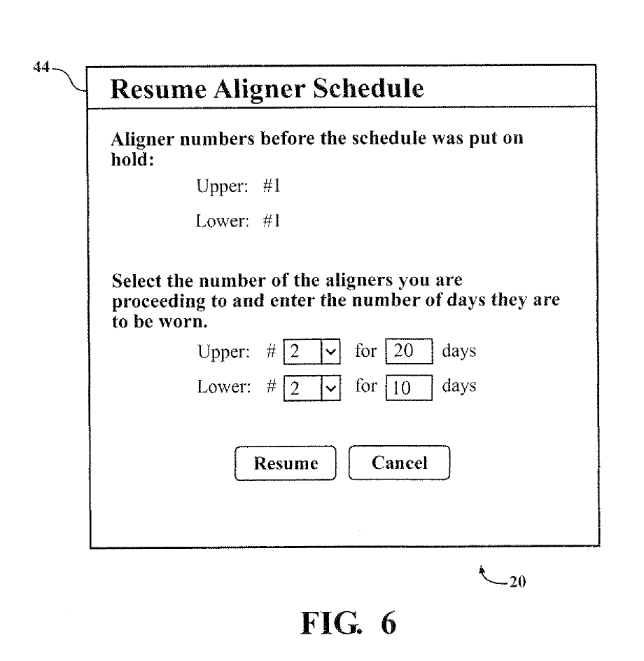

Referring to the Figures, wherein like numerals indicate corresponding parts throughout the several views, a method of developing a schedule of orthodontic aligners using an aligner manager 20, generally shown in FIGS. 1-7, having computer readable instructions stored on a computer readable database. In the preferred embodiment, the aligner manager 20 is in the form of a website in which the computer readable instructions are stored on a computer readable medium of a server. However, the aligner manager 20 could also be an application stored on a smart phone, tablet or the like, as well as a computer program loaded on a personal computer.

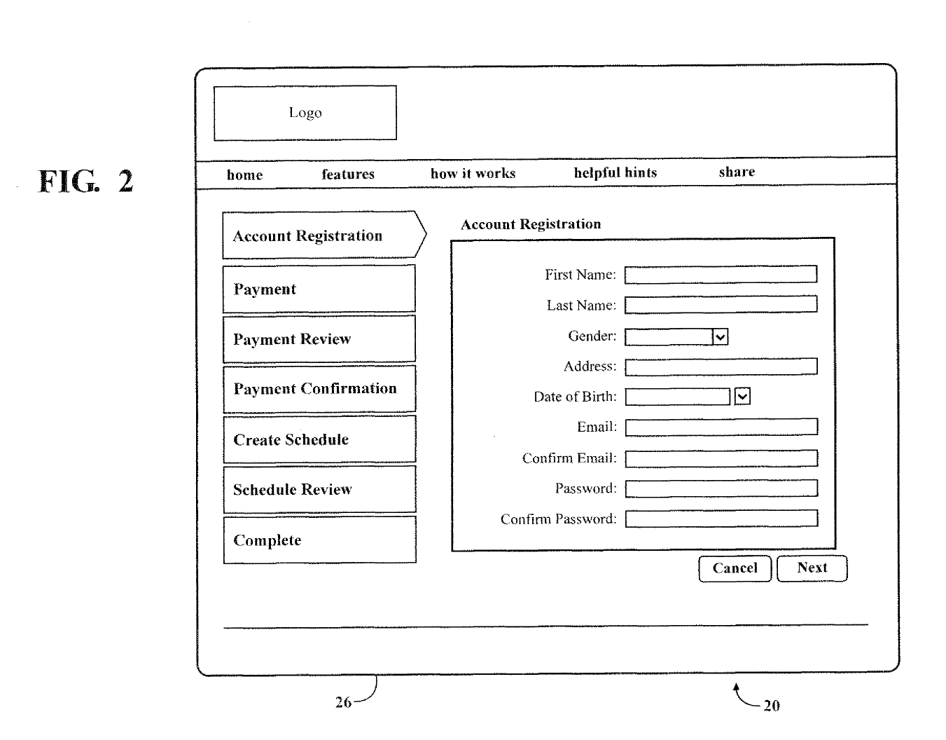

In any of the embodiments of the aligner manager 20, the method comprises presenting a home page 22 of the aligner manager 20 on a graphical user interface for allowing the user to request registration with the aligner manager 20. Consistent with the above embodiments, the graphical user interface could be disposed on a personal computer, smart phone, tablet or the like. Further, in the embodiment where the aligner manager 20 is in the form of a website, the home page 22 is in the form of a webpage. In any of the embodiments, the user can be either an orthodontist or a patient receiving an orthodontic aligner treatment from the orthodontist. Once a registration request is received from the user, a user archive 24 is created on the computer readable database. The method then proceeds by providing the user with a login name and a login password associated with the user archive 24 for allowing the user to access the aligner manager 20. Upon receiving the login name and login password for the first time from the user, a patient registration page 26, as shown in FIG. 2, is presented on the graphical user interface for allowing the user to input a plurality of patient identification inputs including, for example, a first name and a last name and a gender and a date of birth and a mailing address and an email address of the patient. In the embodiment where the aligner manager 20 is in the form of a website, the patient registration page 26 is in the form of a webpage. Once the patient identification inputs are received, they are subsequently stored in the user archive 24.

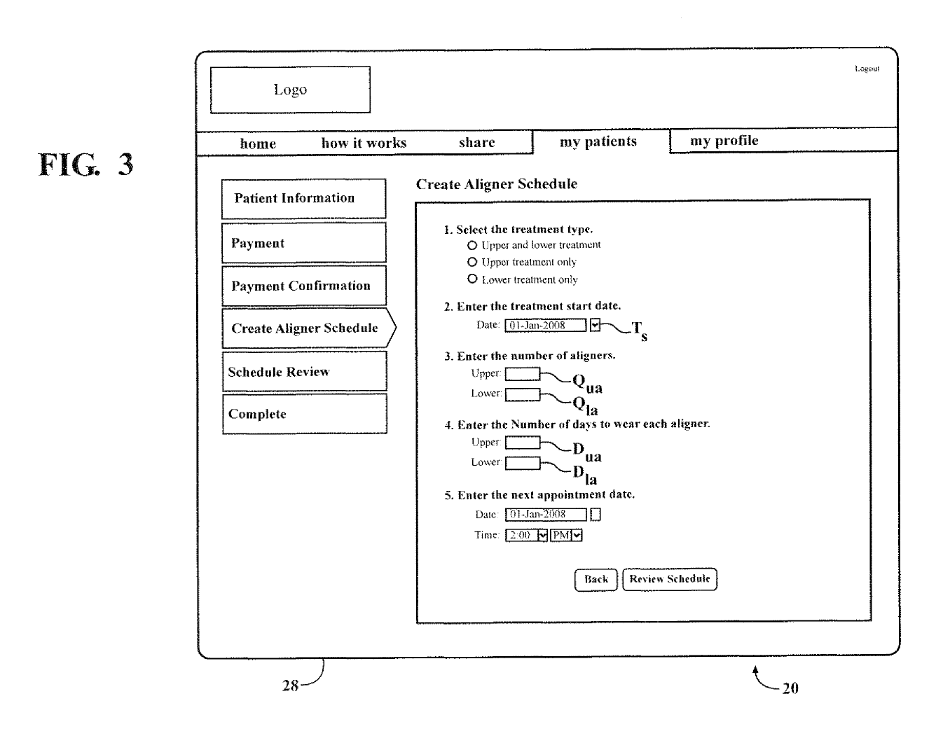

The method proceeds by presenting a create aligner schedule page 28, as shown in FIG. 3, on the graphical user interface for allowing the user to enter a plurality of aligner inputs associated with an orthodontic aligner treatment of the patient. In the embodiment where the aligner manager 20 is in the form of a website, the create aligner schedule page 28 is in the form of a webpage. The orthodontic aligner treatment can consist of a set of upper aligners for straightening upper teeth of the patient or a set of lower aligners for straightening lower teeth of the patient. However, in most situations, the orthodontic aligner treatment includes a set of both upper and lower aligners. In the situation where the user is the orthodontist, the orthodontist will enter the aligner inputs on behalf of the patient for managing an aligner treatment specific to that patient. Alternatively, where the user is the patient, the inputs are personally entered by the patient to assist the patient in managing their own orthodontic treatment. However, when the patient creates their own profile, both the orthodontist and the patient would have access to view and manage the patient's orthodontic treatment schedule.

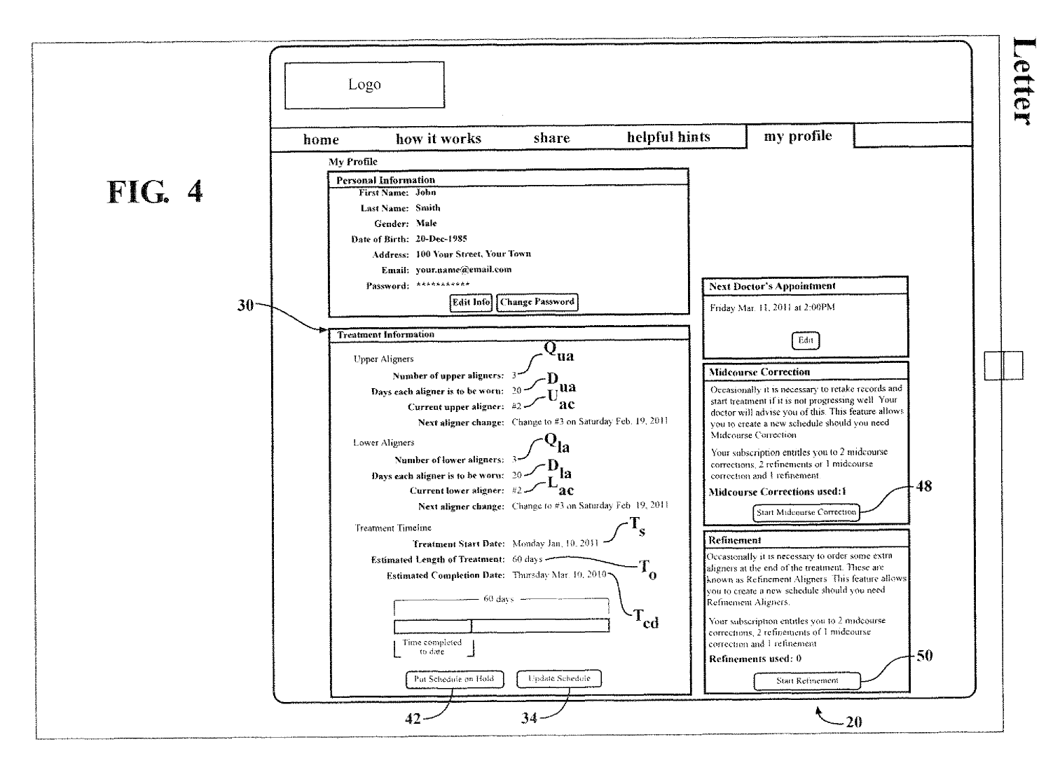

When a single set of aligners is prescribed, the step of receiving the aligner inputs includes receiving and storing an aligner quantity Q to identify a number of prescribed aligners for either the upper or lower aligner set, and an aligner duration D to identify a number of days each aligner in the set is prescribed to be worn and a treatment start date Tₛ to identify a calendar date to commence the orthodontic treatment. The method proceeds by calculating an orthodontic aligner schedule 30, as generally indicated in FIG. 4, according to a plurality of scheduling formulas. This step of calculating the orthodontic aligner schedule 30 includes calculating a first aligner change date A₁ according to a first change date scheduling formula A₁=Tₛ+D to identify a change date associated with a first aligner in either the lower and upper set and calculating a second aligner change date A₂ according to a second change date scheduling formula A₂=A₁+D to identify a date to change a second aligner in the respective set. Each of the first aligner change date A₁ and the second aligner change date A₂ are subsequently stored in the user archive 24. In addition, the step of calculating the orthodontic aligner schedule 30 includes determining an aligner change date for each of the remaining aligners in the respective set. Accordingly, the method proceeds by comparing the number of stored aligner change dates to the aligner quantity Q to generate a first scheduling signal in response to the number of stored aligner change dates being less than the aligner quantity Q. In response to receiving the first scheduling signal, a plurality of remaining aligner change dates Aₓ are calculated according to a remaining change date scheduling formula Aₓ=Aₓ₋₁+D. Once calculated, each of the remaining change dates Aₓ are subsequently stored in the user archive 24.

When both an upper and lower set of aligners are prescribed, the step of receiving and storing the aligner inputs includes receiving an upper aligners quantity Qᵤₐ to identify a number of prescribed upper aligners, a lower aligners quantity Qₗₐ to identify a number of prescribed lower aligners, an upper aligner duration Dᵤₐ to identify a number of days each upper aligner is prescribed to be worn, a lower aligner duration Dₗₐ to identify a number of days each lower aligner is prescribed to be worn and a treatment start date Tₛ to identify a calendar date to commence orthodontic aligner treatment. In addition, the step of calculating the orthodontic aligner schedule 30 includes calculating the schedule for each of the upper and lower sets using the scheduling formulas adapted for the respective upper and lower sets.

For calculating the upper aligner schedule 30, the method proceeds by calculating a first upper aligner change date UA₁ according to a first upper change date formula UA₁=Tₛ+Dᵤₐ to identify a date to change a first upper aligner and calculating a second upper aligner change date UA₂ according to a second upper change date formula UA₂=UA₁+Dᵤₐ to identify a date to change a second upper aligner. Each of the first upper aligner change date UA₁ and the second upper aligner change date UA₂ are stored in the user archive 24. In addition, the step of calculating the orthodontic aligner schedule 30 includes determining an aligner change date for each of the remaining aligners in the upper aligner set. Accordingly, the method proceeds by comparing the number of stored upper aligner change dates to the upper aligners quantity Qᵤₐ to generate a first upper scheduling signal in response to the number of stored upper aligner change dates being less than the upper aligners quantity Qᵤₐ. In response to receiving the first upper scheduling signal, a plurality of remaining upper aligner change dates UAₓ are calculated for each of the remaining upper aligners according to the remaining upper change date scheduling formula UAₓ=UAₓ₋₁+Dᵤₐ, and each of the remaining upper aligner change dates UAₓ are stored in the user archive 24.

For calculating the lower aligner schedule, the method proceeds by calculating a first lower aligner change date LA₁ according to a first lower change date scheduling formula LA₁=Tₛ+D₁ₐ to identify a date to change a first lower aligner and calculating a second lower aligner change date LA₂ according to a second lower change date scheduling formula LA₂=LA₁+Dₗₐ to identify a date to change a second lower aligner. Each of the first lower aligner change date LA₁ and the second lower aligner change date LA₂ are stored in the user archive 24. In addition, the step of calculating the orthodontic aligner schedule 30 includes determining an aligner change date for each of the remaining aligners in the lower aligner set. Accordingly, the method proceeds by comparing the number of stored lower aligner change dates to the lower aligners quantity Qᵤₐ to generate a first lower scheduling signal 56 in response to the number of stored lower aligner change dates being less than the lower aligners quantity Qᵤₐ. In response to receiving the first lower scheduling signal, a plurality of remaining lower aligner change dates LAₓ are calculated for each of the remaining lower aligners according to the remaining lower change date scheduling formula LAₓ=LAₓ₋₁+Dₗₐ, and each of the remaining lower aligner change dates LAₓ are stored in the user archive 24.

In summary, when both an upper and lower set of aligners are prescribed, the aligner quantity Q includes the upper aligners quantity Qᵤₐ and the lower aligners quantity Qₗₐ and the aligner duration D includes the upper aligner duration Dᵤₐ and the lower aligner duration Dₗₐ. With regard to the scheduling formulas, when both an upper and lower set of aligners are prescribed, the first change date formula includes the first upper change date formula and the first lower change date formula, and the second change date scheduling formula includes the second upper change date scheduling formula and the second lower change date scheduling formula. In addition, the first scheduling signal includes the first upper and lower scheduling signals and the remaining change date scheduling formula includes the remaining upper and lower change date scheduling formulas.

The method proceeds by determining a current date of the orthodontic treatment schedule and comparing the current date to the aligner change dates A₁, A₂, Aₓ and determining a current aligner A_{c} scheduled for use and a change date associated with the current aligner A_{c}. In the situation where both an upper and lower set of aligners is prescribed, this step includes comparing the current date to both the upper and lower aligner change dates UA₁, UA₂, UAₓ, LA₁, LA₂, LAₓ and determining a current upper aligner UA_{c} and a current lower aligner LA_{c} scheduled for use and a change date associated with each of the current upper and lower aligners. In response to determining the current aligner, the method proceeds by comparing the aligner change dates A₁, A₂, Aₓ to the current aligner change date and determining a plurality of subsequent aligners Aₛ having associated change dates scheduled after the current aligner change date. Once again, in the situation where both an upper and lower set of aligners is prescribed, this step includes comparing the upper aligner change dates UA₁, UA₂, UAₓ to the current upper aligner change date UA_{c} and determining a plurality of subsequent upper aligners UAₛ having associated upper aligner change dates scheduled after the current upper aligner change date UA_{c}, and comparing the lower aligner change dates LA₁, LA₂, LAₓ to the current lower aligner change date LA_{c} and determining a plurality of subsequent lower aligners LAₛ having associated lower aligner change dates scheduled after the current lower aligner change date LA_{c}. In both situations, the current aligners A_{c}, UA_{c}, LA_{c} and the current aligner change dates and the subsequent aligners Aₛ, UAₛ, LAₛ are stored in the user archive 24.

Once the current and subsequent aligners are determined, the method continues by calculating an aligner timeline T according to a timeline scheduling formula T=Q×D to identify a length of treatment associated with the aligners. In the situation where both an upper and lower sets of aligners are prescribed, the step of calculating the aligner timeline T includes calculating an upper aligner timeline Tᵤₐ according to an upper timeline scheduling formula Tᵤₐ=Qᵤₐ×Dᵤₐ for identifying a length of treatment associated with the upper aligners, and calculating a lower aligner timeline Tₗₐ according to a lower timeline scheduling formula Tₗₐ=Qₗₐ×Dₗₐ for identifying an estimated length of treatment associated with the lower aligners. The calculated aligner timeline T and the calculated upper aligner timeline Tᵤₐ and lower aligner timeline Tₗₐ are stored in the user archive 24. In the situation where both an upper and lower set of aligners are prescribed, the method also includes comparing the upper aligner timeline Tᵤₐ to the lower treatment timeline Tₗₐ and determining an overall treatment timeline Tₒ being equal to the greater of the upper and lower aligner timelines Tᵤₐ, Tₗₐ. The overall aligner timeline Tₒ is stored in the user archive 24, and a treatment completion date T_{cd} is calculated according to an overall timeline scheduling formula T_{cd}=Tₛ+Tₒ to estimate a completion date of the orthodontic treatment. Once calculated, the treatment completion date T_{cd} is stored in the user archive 24.

In the preferred embodiment, the method also includes requesting a next appointment date from the user in response to receiving the plurality of aligner schedule 30 inputs to identify a scheduled date of an orthodontist appointment. Upon receiving the next orthodontist appointment date, the appointment date is stored in the user archive 24. As shown in FIG. 4, the next orthodontist appointment date includes the day, date and time of the next appointment. Receiving this date is helpful because it provides additional information to both the orthodontist and the patient to assist in managing the orthodontic aligner treatment. If no dates are entered, the aligner manager 20 can inform the patient and orthodontist that there are no upcoming orthodontist appointments.

The method proceeds by presenting an interactive profile page 32 on the graphical user interface for displaying a summary of the calculated orthodontic aligner schedule 30 including a summary of the plurality of aligner schedule inputs Q, D, Tₛ, the treatment timeline T, the current aligner A_{c}, the scheduled change date for the current aligner and the next orthodontist appointment date for allowing the user to interact with the aligner manger 20 and independently manage the orthodontic aligners. In other words, the interactive profile page 32 presents a snapshot of the orthodontic aligner treatment to the user. In particular, the user is able to see how far along the treatment is, when their estimated date of completion is, the current aligners they are using, and when the next change is required. This summary is advantageous because it allows the user to track and independently manage the progress of the orthodontic treatment. In the embodiment where the aligner manager 20 is in the form of a website, the interactive profile page 32 is in the form of a webpage and allows the user to interact with a website to manage the orthodontic aligners.

When both an upper and lower aligner set is prescribed, the step of presenting an interactive profile page 32 on the graphical user interface includes displaying a summary of the aligner inputs Qᵤₐ, Uₗₐ, Dᵤₐ, Dₗₐ, Tₛ, the treatment timelines Tᵤₐ, Tₗₐ, T_{cd}, Tₒ the current upper and lower aligners UA_{c}, LA_{c}, the current scheduled change dates for the upper and lower aligners, and the next orthodontist appointment date. As shown best shown in FIG. 4, the overall treatment timeline Tₒ can be presented to the user in the form of a bar chart. Also, if the user has logged out of the aligner manager 20, the user is presented with a view archived patient page upon reentering the aligner manager 20 to allow the user to enter the login name and password and request access to the user archive 24. Upon receiving the login name and login password and the access archive request, the interactive profile page 32 is presented on the graphical user interface.

In addition, the step of presenting an interactive profile page 32 on the graphical user interface includes presenting a plurality of interactive schedule prompts 34, 42, 48, 50 on the graphical user interface for allowing the user to enter at least one treatment preference and request a recalculation of the orthodontic schedule using the preference and the scheduling formulas. In the embodiment where the aligner manager 20 is in the form of a website, the interactive schedule prompts 34, 42, 48, 50 are presented on a webpage. In the preferred embodiment, the step of presenting a plurality of interactive schedule prompts 34, 42, 48, 50 includes presenting an update schedule prompt 34 on the graphical user interface for allowing the user to request a preference to update the orthodontic treatment schedule. In response to receiving the update schedule request, the current aligner A_{c} and the change date associated with the current aligner A_{c} are identified, and the method proceeds by presenting an update aligner schedule page 36 on the graphical user interface for allowing the user to input at least one treatment schedule extension E to identify a number of days to extend the aligner change dates. When both an upper and lower set of aligners are prescribed, the current upper aligner UA_{c} and the current lower aligner LA_{c} and the respective change dates associated with each of the current upper and lower aligners UA_{c}, LA_{c} are identified, and the at least one treatment schedule extension E includes a current upper aligner extension Eᵤₐ and a current aligner extension Eₗₐ to identify a number of days to extend the respective upper and lower aligner change dates.

Upon receiving the at least one treatment schedule extension E, the method proceeds by recalculating the orthodontic aligner schedule 30 according to a timeline extension formula wherein the change date associated with the current aligner and each of the subsequent aligners is advanced by the at least one treatment schedule extension E. In addition, the method proceeds by recalculating the aligner timeline T according to a timeline extension scheduling formula wherein the aligner timeline T is advanced by the aligner schedule extension E. Upon recalculation, the recalculated aligner change dates and the recalculated aligner timeline are stored in the user archive 24, and the step of presenting the interactive profile page 32 includes displaying a summary of the recalculated aligner change dates and the recalculated aligner timeline on the graphical user interface.

When both an upper and lower aligner set are prescribed, upon receiving the current upper aligner extension Eᵤₐ the method proceeds by recalculating the orthodontic schedule according to an upper treatment extension scheduling formula wherein the change date associated with the current upper aligner and each of the subsequent upper aligners is advanced by the upper aligner extension Eᵤₐ. In addition, the orthodontic aligner schedule 30 is recalculated according to a lower treatment extension scheduling formula wherein the change date associated with the current lower aligner and each of the subsequent lower aligners is advanced by the lower aligner extension Eₗₐ. Each of the recalculated upper and lower aligner dates are stored in the user archive 24. In addition, the method proceeds by comparing the upper aligner extension to the lower aligner extension and recalculating the overall treatment timeline Tₒ according to a treatment extension scheduling formula wherein the overall treatment timeline Tₒ is advanced by the greater of the upper and lower aligner extensions Eᵤₐ, Eₗₐ. After recalculation, the overall treatment timeline Tₒ is stored in the user archive 24 and the step of presenting the interactive profile page 32 includes presenting a summary of the recalculated aligner change dates and the recalculated overall treatment timeline.

In the preferred embodiment, the step of presenting an update aligner schedule page 36 includes presenting at least one aligner dropdown list 38, 40 on the graphical user interface to select one of the subsequent aligners for allowing the user to input a future aligner extension for a selected subsequent aligner. When an upper and lower aligner set is prescribed, the aligner dropdown list 38, 40 includes an upper aligner dropdown list 38 for entering a future extension for one of the subsequent upper aligners and a lower aligner dropdown list 40 for entering a future extension for one of the subsequent lower aligners. Upon receiving the future aligner extension, the method proceeds by recalculating the orthodontic aligner schedule 30 according to a future treatment extension scheduling formula wherein the change date associated with the selected subsequent aligner and each of the aligners having a change date scheduled after the selected subsequent aligner is advanced by the future aligner extension. In addition, the method proceeds by recalculating the aligner timeline T according to a future timeline extension scheduling formula wherein the aligner timeline T is advanced by the future aligner extension. When an upper and lower set of aligners are prescribed, the upper aligner timeline Tᵤₐ and the lower aligner timeline Tₗₐ and the overall timeline Tₒ and the treatment completion date T_{cd} are recalculated according to the future timeline extension scheduling formula wherein each of the timelines Tᵤₐ, Tₗₐ, Tₒ, T_{cd} is advanced by the future aligner extension. Upon completing the recalculation, the step of presenting the interactive profile webpage 32 includes presenting a summary of the recalculated aligner change dates and the recalculated overall treatment timeline.

In the preferred embodiment, the step of presenting a plurality of interactive schedule prompts 34, 42, 48, 50 also includes presenting a put schedule on hold prompt 42 on the graphical user interface for allowing the user to request a suspension of the orthodontic treatment schedule. Upon receiving a suspension request, a suspension date is identified and stored in the user archive 24 and the orthodontic treatment schedule is suspended. Correspondingly, the method proceeds by presenting a resume aligner schedule page 44 on the graphical user interface in response to suspension of the orthodontic treatment schedule for allowing the user to input at least a resume schedule request to restart the orthodontic treatment schedule. Once a restart request is received from the user, a restart date is identified and stored in the user archive 24, and a number of days the orthodontic schedule was suspended is calculated according to a suspension scheduling formula wherein the suspension date is subtracted from the restart date. When a single set of aligners is prescribed, the method proceeds by identifying the current aligner A_{c} and the respective change date associated with the current aligner A_{c} in response to receiving the restart request, and the current aligner change date and each of the change dates associated with the subsequent aligners are recalculated according to a restart scheduling formula where each of the change dates are advanced by the number of suspended days. When an upper and lower set of aligners are prescribed, the method includes identifying the current upper aligner UA_{c} and the current lower aligner LA_{c} and the respective change dates associated with each of the current aligners UA_{c}, LA_{c} in response to receiving the restart request, and the current upper aligner change date and each of the change dates associated with the subsequent upper aligners are recalculated according to a restart scheduling formula wherein each of the upper change dates is advanced by the number of suspended days. In addition, the current lower aligner change date and each of the change dates associated with the subsequent lower aligners are recalculated according to a restart scheduling formula wherein each of the lower change dates is advanced by the number of suspended days. Each of the recalculated aligner change dates are then stored in the user archive 24. When a single set of aligners are prescribed, the method also includes recalculating the aligner timeline T according to the restart scheduling formula wherein the timeline T is advanced by the number of suspended days. When an upper and lower set of aligners are prescribed, the method includes recalculating the upper aligner timeline Tᵤₐ and the lower aligner timeline Tₗₐ and the overall timeline Tₒ and the treatment completion date T_{cd} according to the restart scheduling formula wherein each of the timelines Tᵤₐ, Tₗₐ, Tₒ, T_{cd} is advanced by the number of suspended days. Each of the recalculated timelines are stored in the user archive 24, and the step of presenting the interactive profile page 32 includes presenting a summary of the recalculated aligner change dates and the recalculated aligner timelines on the graphical user interface.

In the preferred embodiment, the step of presenting a plurality of interactive schedule prompts 34, 42, 48, 50 includes presenting a start midcourse correction prompt 48 on the graphical user interface for allowing the user to input a plurality of midcourse treatment inputs. This step is advantageous because occasionally it is necessary to adjust the treatment if it is not progressing well. For example, a problem with one of the aligners may be encountered by the patient, such as the aligner is not fitting properly or the aligner is not worn for an adequate amount of time. Accordingly, the method allows for the inclusion of midcourse corrections or refinements to address these issues. Upon receiving midcourse treatment inputs from the orthodontist or the patient, the orthodontic treatment plan is recalculated and stored in the user archive 24. In other words, the orthodontic treatment plan is recalculated using the plurality of patient inputs along with the midcourse treatment inputs through the use of the plurality of scheduling formulas. After the midcourse correction, the step of presenting the interactive profile webpage 32 includes presenting a summary of the recalculated orthodontic treatment plan including the midcourse treatment inputs.

In the preferred embodiment, the step of presenting a plurality of interactive schedule prompts 34, 42, 48, 50 also includes displaying a start refinement prompt 50 on the graphical user interface for allowing the user to input a plurality of treatment refinement inputs. In contrast to a midcourse correction, sometimes it is necessary to order extra aligners at the end of the orthodontic treatment which are known as refinement aligners. Therefore, the method includes the refinement feature to allow the creation of a new schedule should refinement aligners be required. Accordingly, the method proceeds by recalculating the orthodontic treatment plan in response to the treatment refinement inputs and storing the recalculations in the user archive 24. In other words, the orthodontic treatment plan is recalculated using the plurality of patient inputs along with the treatment refinement inputs through the use of the plurality of scheduling formulas. Once the schedule for the refinement aligners is created, the step of presenting the interactive profile page 32 includes displaying a summary of the recalculated orthodontic treatment plan according to the treatment refinement inputs.

After the orthodontic treatment schedule has been calculated, it is advantageous to create and send automatic reminders in real time to the patient to increase communication with the patient and improve their compliance with the orthodontic aligner schedule 30. Accordingly, in the preferred embodiment, the method includes comparing the current date to the aligner change dates and generating a first messaging signal in response to the current date being the same as one of the aligner change dates. In response to the first messaging signal, a first email or text message is sent to the patient to remind the patient to end use of the current aligner A_{c} and begin use of one of the subsequent aligners Aₛ in the orthodontic treatment schedule. In the situation where both an upper and lower aligner sets are prescribed, the method includes comparing the current date to the upper aligner change dates and generating a first upper message signal in response to the current date being the same as one of the upper aligner change dates and comparing the current date to the lower aligner change dates and generating a first lower message signal in response to the current date being the same as one of the lower aligner change dates. In response to the first upper message signal, a first upper email or text message is sent to the patient for reminding the patient to end use of the current upper aligner UA_{c} and begin use of a subsequent upper aligner UAₛ in the treatment schedule. Also, in response to the first lower message signal, a first lower email or text message is sent to the patient for reminding the patient to end use of the current lower aligner LA_{c} and begin use of a subsequent lower aligner LAₛ in the treatment schedule.

To further improve communication with the patient and assist in managing the aligner schedule 30, in the preferred embodiment the method includes automatically generating reminders of upcoming orthodontist appointments. Accordingly, the method includes comparing the current date to the next orthodontist appointment date previously received from the patient and generating a second messaging signal in response to the current date being the same as the next orthodontist appointment date. In response to the second messaging signal, a second email or text message is sent to the patient for reminding the patient of the orthodontist appointment.

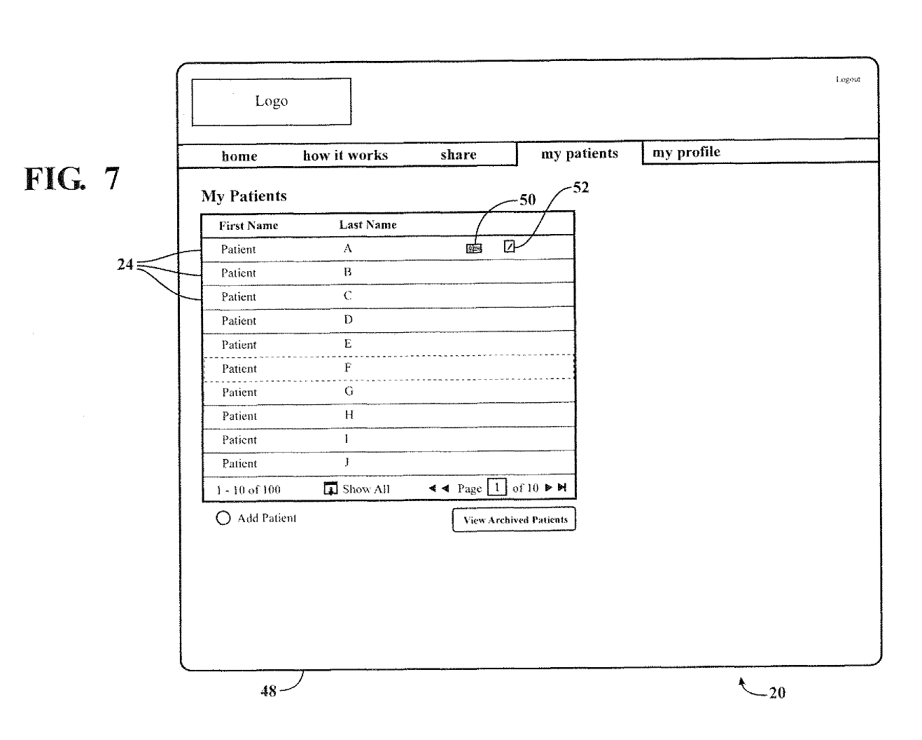

As previously mentioned, the user could be an orthodontist who uses the method to track and manage their patient's schedule and progress. Accordingly, when the user is an orthodontist, the method includes presenting a my patients page 48 to the orthodontist for allowing the patient to view a list of enrolled patients. In the embodiment where the aligner manager 20 is in the form of a website, the my patients page 48 is in the form of a webpage. As shown in FIG. 7, the my patients page 48 presents the user archives associated with the active patients in alphabetic order and presents a profile link 50 associated with each patient archive 24 for allowing the orthodontist to view a summary of the aligner schedule 30 for each patient. In addition, the my patients page 48 presents a notes link 52 associated with each patient archive 24 for allowing the orthodontist to enter notes for the patient. The notes are received and stored in the patient archive 24 for future access and review by the orthodontist.

Obviously, many modifications and variations of the present invention are possible in light of the above teachings and may be practiced otherwise than as specifically described while within the scope of the appended claims.

What is claimed is:

1. A method of managing a schedule of orthodontic aligners using an aligner manager having computer readable instructions stored on a computer readable medium, said method comprising:
presenting a home page of the aligner manager on a graphical user interface for allowing a user to request registration with the aligner manager;
creating a user archive in response to the registration request;
presenting a create aligner schedule page on the graphical user interface for allowing the user to enter a plurality of aligner inputs associated with an orthodontic aligner treatment;
receiving and storing the aligner inputs in the user archive;
calculating an orthodontic aligner schedule according to a plurality of scheduling formulas; and
presenting an interactive profile page on the graphical user interface for displaying a summary of the calculated orthodontic aligner schedule and for allowing the user to interact with the aligner manager and independently manage the orthodontic aligners.

2. A method as set forth in claim 1 wherein said step of presenting the interactive profile page on the graphical user interface includes presenting a plurality of interactive schedule prompts to the user for allowing the user to enter at least one treatment preference and request a recalculation of the orthodontic aligner schedule using the preference and the scheduling formulas.

3. A method as set forth in claim 2, further comprising:
said step of receiving and storing the aligner schedule inputs includes receiving and storing an aligner quantity (Q) to identify a number of prescribed aligners and an aligner duration (D) to identify a number of days each aligner is prescribed to be worn and a treatment start date (Tₛ) to identify a calendar date to commence orthodontic treatment;
said step of calculating the orthodontic aligner schedule includes calculating a first aligner change date (A₁) according to a first change date scheduling formula A₁=Tₛ+D for identifying a date to change a first aligner; and
storing the first aligner change date (A₁) in the user archive.

4. A method as set forth in claim 3, further comprising:
said step of calculating the orthodontic aligner schedule includes calculating a second aligner change date (A₂) according to a second change date scheduling formula A₂=A₁+D for identifying a date to change a second aligner;
storing the second aligner change date (A₂) in the user archive;
comparing the number of stored aligner change dates to the aligner quantity (Q) to generate a first scheduling signal in response to the number of stored aligner change dates being less than the aligner quantity (Q);
said step of calculating the orthodontic aligner schedule includes calculating a plurality of remaining aligner change dates (Aₓ) in response to the first scheduling signal for each of the remaining aligners according to a remaining change date scheduling formula Aₓ=Aₓ₋₁+D; and
storing each of the remaining aligner change dates (Aₓ) in the user archive.

5. A method as set forth in claim 4, further comprising:
determining a current date of the orthodontic aligner schedule;
comparing the current date to the aligner change dates to determine a current aligner (A_{c}) scheduled for use and a change date associated with the current aligner (A_{c});
comparing the aligner change dates to the current aligner change date to determine a plurality of subsequent aligners (Aₛ) having associated change dates scheduled after the current aligner change date;
storing the current aligner (A_{c}) and the subsequent aligners (Aₛ) in the user archive; and
said step of presenting the interactive profile page includes displaying a summary of the aligner inputs and the current aligner (A_{c}) and the current aligner change date.

6. A method as set forth in claim 5, further comprising:
said step of calculating said orthodontic schedule including calculating an aligner timeline (T) according to a timeline scheduling formula T=Q×D for identifying a length of treatment associated with the aligners;
storing the aligner timeline (T) in the user archive; and
said step of presenting the interactive profile page includes displaying a summary of the aligner timeline (T).

7. A method as set forth in claim 6, further comprising:
said step of presenting a plurality of interactive schedule prompts includes presenting an update schedule prompt on the graphical user interface for allowing the user to request a preference to update the orthodontic treatment schedule; and
presenting an update aligner schedule page on the graphical user interface in response to receiving the update schedule request for allowing the user to input a treatment schedule extension (E) to identify a number of days to extend the aligner change dates.

8. A method as set forth in claim 7 further comprising:
recalculating the orthodontic aligner schedule according to a treatment extension scheduling formula wherein the respective change date associated with the current aligner (A_{c}) and each of the subsequent aligners (Aₛ) is advanced by the aligner schedule extension (E);
recalculating the aligner timeline (T) according to a timeline extension scheduling formula wherein the treatment timeline is advanced by the aligner schedule extension (E);
storing the recalculated aligner change dates and the recalculated aligner timeline in the user archive; and
said step of presenting the interactive profile page includes displaying a summary of the recalculated aligner change dates and the recalculated treatment timeline on the graphical user interface.

9. A method as set forth in claim 7 further comprising:
said step of presenting the update aligner schedule page includes presenting at least one aligner dropdown list on the graphical user interface to select one of the subsequent aligners (Aₛ) for allowing the user to input a future aligner extension for the selected subsequent aligner;
identifying the selected subsequent aligner and the aligner change date associated with the selected subsequent aligner;
recalculating the orthodontic aligner schedule according to a future treatment extension scheduling formula wherein the change dates associated with the selected subsequent aligner and each of the aligners having a change date scheduled after the selected subsequent aligner are advanced by the future aligner extension;
recalculating the aligner timeline (T) according to a future timeline extension scheduling formula wherein the treatment timeline is advanced by the future aligner extension;
storing the recalculated aligner change dates and the recalculated aligner timeline in the user archive; and
said step of presenting the interactive profile page includes displaying a summary of the recalculated aligner change dates and the recalculated treatment timeline.

10. A method as set forth in claim 6, further comprising:
said step of presenting a plurality of interactive schedule prompts includes presenting a put schedule on hold prompt on the graphical user interface to allow the user to request a suspension of the orthodontic treatment schedule;
identifying a suspension date in response to receiving the suspension request and storing the suspension date in the user archive; and
suspending the orthodontic treatment schedule in response to the suspension request.

11. A method as set forth in claim 10 further comprising:
presenting a resume aligner schedule page on the graphical user interface in response to suspension of the orthodontic treatment schedule for allowing the user to input at least a resume schedule request to restart the orthodontic treatment schedule;
calculating a number of days the orthodontic treatment schedule is suspended according to a suspension scheduling formula wherein the suspension date is subtracted from the restart date;
identifying the current aligner (A_{c}) and the respective change date associated with the current aligner in response to receiving the restart request;
recalculating the current aligner change date and each of the change dates associated with the subsequent aligners (Aₛ) and the aligner timeline (T) according to a restart scheduling formula wherein each of the change dates and the timeline (T) are advanced by the number of suspended days;
storing the recalculated change dates and the recalculated timeline in the user archive; and
said step of presenting the interactive profile page includes displaying a summary of the recalculated aligner change dates and the recalculated aligner timeline.

12. A method as set forth in claim 6 further comprising:
said step of presenting a plurality of interactive schedule prompts includes presenting a start midcourse correction prompt on the graphical user interface for allowing the user to input a plurality of midcourse treatment inputs;
recalculating the orthodontic treatment plan in response to the midcourse treatment inputs; and
said step of presenting the interactive profile page on the graphical user interface includes displaying a summary of the recalculated orthodontic aligner plan.

13. A method as set forth in claim 6 further comprising:
said step of presenting a plurality of interactive schedule prompts includes presenting a start refinement prompt on the graphical user interface for allowing the user to input a plurality of treatment refinement inputs;
recalculating the orthodontic treatment plan in response to the treatment refinement inputs; and
said step of presenting the interactive profile page includes displaying a summary of the recalculated orthodontic aligner plan.

14. A method as set forth in claim 5, further comprising:
presenting a patient registration page on the graphical user interface in response to receiving the registration request for allowing the user to input a plurality of patient identification inputs including a name of a patient and an email address of the patient;
receiving and storing the patient identification inputs in the patient archive;
comparing the current date to the aligner change dates and generating a first message signal in response to the current date being the same as one of the aligner change dates; and
sending a first message to the patient in response to the first message signal for reminding the patient to end use of the current aligner (A_{c}) and begin use of one of the subsequent aligners (Aₛ) in the orthodontic aligner schedule.

15. A method of as set forth in claim 14, further comprising:
requesting a next orthodontist appointment date from the user in response to receiving the aligner schedule inputs to identify a scheduled date of an orthodontist appointment;
receiving and storing the next orthodontist appointment in the user archive;
said step of presenting the interactive profile page includes displaying a summary of the next orthodontist appointment;
comparing the current date to the next orthodontist appointment date and generating a second messaging signal in response to the current date being the same as the next orthodontist appointment date; and
sending a second message to the patient in response to the second messaging signal for reminding the patient of the orthodontist appointment.

16. A method as set forth in claim 2, further comprising:
said step of receiving and storing the aligner schedule inputs includes receiving and storing an upper aligners quantity (Qᵤₐ) to identify a number of prescribed upper aligners and a lower aligners quantity (Qₗₐ) to identify a number of prescribed lower aligners and an upper aligner duration (Dᵤₐ) to identify a number of days each upper aligner is prescribed to be worn and a lower aligner duration (Dₗₐ) to identify a number of days each lower aligner is prescribed to be worn;
said step of calculating the orthodontic schedule includes calculating a first upper aligner change date (UA₁) according to a first upper change date scheduling formula UA₁=Tₛ+Dᵤₐ to identify a date to change a first upper aligner;
said step of calculating the orthodontic schedule includes calculating a first lower aligner change date (LA₁) according to a first lower change date scheduling formula LA₁=Tₛ+Dₗₐ to identify a date to change a first lower aligner; and
storing the first upper and lower aligner change dates (UA₁, LA₁) in the user archive.

17. A method as set forth in claim 16, further comprising:
said step of calculating the orthodontic schedule includes calculating a second upper aligner change date (UA₂) according to a second upper change date scheduling formula UA₂=UA₁+Dᵤₐ to identify a date to change a second upper aligner;
comparing the number of stored upper aligner change dates to the upper aligner quantity (Qᵤₐ) to generate a first upper scheduling signal in response to the number of stored upper aligner change dates being less than the upper aligner quantity (Qᵤₐ);
said step of calculating the orthodontic schedule includes calculating a plurality of remaining upper aligner change dates (UAₓ) in response to the first upper scheduling signal for each of the remaining upper aligners according to the remaining upper change date scheduling formula UAₓ=UAₓ₋+Dᵤₐ;
said step of calculating the orthodontic schedule includes calculating a second lower aligner change date (LA₂) according to a second lower change date scheduling formula LA₂=LA₁+Dₗₐ to identify a date to change a second lower aligner;
comparing the number of stored lower aligner change dates to the lower aligner quantity (Qₗₐ) to generate a first lower scheduling signal in response to the number of stored lower aligner change dates being less than the upper aligner quantity (Qₗₐ);
said step of calculating the orthodontic schedule includes calculating a plurality of remaining lower aligner change dates (LAₓ) in response to the first lower scheduling signal for each of the remaining lower aligners according to the remaining lower change date scheduling formula LAₓ−LAₓ₋₁+Dₗₐ; and
storing each of the upper and lower aligner change dates (UA₂, LA₂, UAₓ, LAₓ) in the user archive.

18. A method as set forth in claim 17, further comprising:
determining a current date of the orthodontic aligner schedule;
comparing the current date to the upper aligner change dates and the lower aligner change dates and determining a current upper aligner (UA_{c}) and a current lower aligner (LA_{c}) scheduled for use by the patient and a change date associated with each of the current upper and lower aligners (UA_{c}, LA_{c});
storing the current upper aligner (UA_{c}) and the current lower aligner (LA_{c}) and the current upper and lower change dates in the user archive; and
said step of presenting the interactive profile page includes displaying a summary of the aligner inputs and the current upper aligner (UA_{c}) and the current lower aligner (LA_{c}) and the current upper and lower change dates.

19. A method as set forth in claim 18, further comprising:
said step of calculating the orthodontic schedule includes calculating an upper aligner timeline (Tᵤₐ) according to an upper timeline scheduling formula Tᵤₐ=Qᵤₐ×Dᵤₐ to identify a length of treatment associated with the upper aligners;
said step of calculating the orthodontic schedule includes calculating a lower aligner timeline (Tₗₐ) according to a lower timeline scheduling formula Tₗₐ=Qₗₐ×Dₗₐ to identify an estimated length of treatment associated with the lower aligners;
storing the upper and lower aligner timelines (Tᵤₐ, Tₗₐ) in the user archive;
comparing the upper aligner timeline (Tᵤₐ) to the lower treatment timeline (Tₗₐ) to determine an overall treatment timeline (Tₒ) being equal to the greater of the upper and lower aligner timelines (Tᵤₐ, Tₗₐ);
storing the overall aligner timeline (Tₒ) in the user archive;
calculating a treatment completion date (T_{cd}) according to an overall timeline scheduling formula T_{cd}=Tₛ+Tₒ to estimate a completion date of the orthodontic treatment; and
said step of presenting the interactive profile page includes displaying a summary of the overall treatment timeline (Tₒ) and the treatment completion date (T_{cd}) on the graphical user interface.
